(19) United States
(12) Patent Application Publication
(10) Pub. No.: US 2005/0074518 A1
(43) Pub. Date: Apr. 7, 2005

(54) Chewing gum-containing tablet

(76) Inventor: Cristiana Soldani, Milano (IT)

Correspondence Address: WINSTON & STRAWN;PATENT DEPARTMENT, 1400 L STREET, N.W., WASHINGTON, DC, 20005-3502, US

(21) Appl. No.: 10/670,208

(22) Filed: Sep. 26, 2003

Related U.S. Application Data
(63) Continuation of application No. PCT/EP02/03064, filed on Mar. 19, 2002.

(30) Foreign Application Priority Data
Mar. 29, 2001 (GB) 0107954.0

(51) Int. Cl. A23G 3/30

(52) U.S. Cl. 426/3

(57) ABSTRACT

A chewing gum-containing tablet made of a compressed mixture of gum base and a tablet base, such that, when masticated, the tablet initially exhibits a first crumbly stage in which the tablet breaks into particles, followed by a second, chewing gum stage in which the particles form a wad of chewing gum.

### CROSS-REFERENCE TO RELATED APPLICATIONS

This application is a continuation of International application PCT/EP02/03064 filed Mar. 19, 2002, the entire content of which is expressly incorporated herein by reference thereto.

### FIELD OF THE INVENTION

The present invention relates to a chewing gum-containing tablet which has a novel effect in the mouth by combining the properties of a tablet with those of a chewing gum.

### BACKGROUND OF THE INVENTION

Ordinary chewing gum contains a generally neutral and essentially tasteless insoluble masticatory gum base which is usually a plasticized rubber or polymer which is softened and has added texturizers, anti-tacking agents and antioxidants, etc. The base is to be chewed rather than eaten in itself and is a vehicle for one or more non-masticatory active ingredients such as flavors and sweeteners.

U.S. Pat. No. 4,741,905 discloses a chewing gum hard candy confection which softens in the mouth to a chewable mass upon mastication prepared by mixing a melted gum base with a cooked hard candy syrup and cooling to a hard candy matrix. Hard candy is usually made from a base of a bulk sweetener such as sugar and glucose syrup which normally contain about 95-98% of the product. The hard candy syrup comprising sugar, glucose syrup and water is cooked to a temperature of 127° to 185° C. before adding the melted chewing gum base.

Tablets are characterized by being hard and somewhat brittle with a smooth surface and differ from hard candy in that they are formed by compressing a tablet base powder in a die where the particles bond together under pressure and the compacted tablet is ejected from the die. The tablet base material is a sugar or a polyol, e.g., sucrose, fructose, dextrose, sorbitol, mannitol, maltitol or xylitol. Tablets may be chewed in a crumbly state and eventually swallowed.

### SUMMARY OF THE INVENTION

The present invention comprises a chewing gum-containing tablet which has a novel and unique effect in the mouth by combining the properties of a tablet with those of a chewing gum. The tablet of the present invention has a hard crumbly initial eat typical of a pressed sweet like Poloa which changes to a chewing gum stage.

Accordingly, the present invention comprises a chewing gum-containing tablet comprising a compressed mixture of gum base and a tablet base, such that, when masticated, the tablet initially exhibits a first crumbly stage in which the tablet breaks into particles, followed by a second chewing gum stage in which the particles form a wad of chewing gum.

The invention also relates to a process for the preparation of a chewing gum-containing which comprises mixing a particulated gum base with a particulated tablet base material and compressing the mixture in a tablet press to enable it to bind together and form a firm compact tablet having the features disclosed herein.

### DETAILED DESCRIPTION OF THE PREFERRED EMBODIMENTS

The chewing gum-containing tablet according to the invention may be prepared from a gum base and a tablet base material in particulate form.

The chewing gum-containing tablet may be prepared by compressing a mixture of the gum base and the tablet base material in powder form. The particle sizes of the gum base and the tablet base may range from 10 microns to 2 mm, but the average particle size may be from 20 to 160 microns, preferably from 40 to 120 microns and more preferably from 50 to 100 microns.

The gum base may any gum base well known to those skilled in the art and may be a plasticized rubber or polymer which may have added texturizers, anti-tacking agents and antioxidants. A particularly advantageous gum base is ARTICA-T made by Cafosa Gum S/A of Barcelona, Spain. Artica-T is composed of the following classes of materials: specially purified elastomeric polymers, resins, refined waxes, glycerol esters of edible fatty acids, talc, antioxidant.

The tablet base material may contain sugar or be sugar-free is preferably based on a sugar or a polyol, for example, sucrose, fructose, lactose, dextrose, sorbitol, mannitol, maltitol, xylitol, isomalt, glucose syrup, maltitol syrup or eritrithol.

Preferably, the gum base is present in an amount of from 5% to 99%, preferably from 10% to 50% and more preferably from 20% to 30% by weight and the tablet base is present in an amount from 1% to 95%, preferably from 50% to 90% and more preferably from 70% to 80% by weight based on the weight of the product.

Preferably, the chewing gum-containing tablet may contain a binder, a lubricant, a flavor or a color.

Optionally, the chewing gum-containing tablet may contain an active ingredient. The active ingredient may be a pharmaceutical, medicated, nutritive or functional ingredient, a dental vehicle such as casein glyco-macro-peptide (CGMP) or a breath freshener. For instance, the active ingredient may be any vitamin, enzyme, amino-acid supplement, protein, gum, carbohydrate, phytochemical, dextrose, lecithin, other trace nutrient, brain-stimulating substance, energy provider, a mineral, mineral salt, botanical extract, antioxidant, prebiotic, probiotic bacteria, fatty acid, oat beta glucan or other functional fiber, creatine, camitine, bicarbonate, citrate, or any mixture thereof.

The amount of active ingredient present in the chewing gum-containing tablet may depend on requirements and the actual ingredient used. For instance, some active ingredients have high functional activity at very low doses such as vitamins and minerals (micronutrients), whereas others such as dextrose (macronutrients) are beneficial to the body in much higher amounts. Furthermore, plant extracts may only contain small amounts of active constituents within the bulk of the extract and may therefore need to be added in larger amounts to ensure sufficient effective quantities of the active parts. The amount of active ingredient may, for example, be from up to 0.00000001 to 15% by weight of the chewing gum-containing tablet depending upon the ingredient. The amount of most ingredients is usually less than 1% by weight, and preferably from 0.000001 to 0.5% by weight of the chewing gum-containing tablet.

CGMP may be used in amounts up to 15%, preferably from 1 to 12% and more preferably from 2.5 to 10% by weight of the chewing gum-containing tablet.

The mineral may be calcium, iron, selenium, zinc, magnesium, phosphorus, iodine, manganese, iron, boron or copper, molybdenum, potassium, chromium, vanadium or fluoride.

The phytochemical may be a polyphenol, procyanidin or a phenolic acid, catechin or epicatechin, isoflavone, terpene or other phytonutritive plant material.

The botanical extract may be selected from Guarana, Gingko Biloba, Kola nut, Goldenseal, Golo Kola, Schizandra, Elderberry, St. John's Wort, Valerian and Ephedra, beta-sitosterol, caffeine, cafestol, D-limonene, kabweol, nomilin, oltipraz, sulphoraphane, tangeretin, black tea, white tea, java tea, folic acid, garlic oil, fiber, green tea extract, lemon oil, mace, licorice, menthol, onion oil, orange oil, rosemary extract, milk thistle extract, Echinacea, Siberian ginseng or Panax ginseng, lemon balm, Kava Kava, matte, bilberry, soy, grapefruit, seaweed, hawthorn, lime blossom, sage, clove, basil, curcumin, taurine, wild oat herb, dandelion, gentian, aloe vera, hops, cinnamon, peppermint, grape, chamomile, fennel, marshmallow, ginger, slippery elm, cardamon, coriander, anise, thyme, rehmannia, eucalyptus, menthol, kava kava, schisandra, withania, cowslip, lycium, passion flower.

The antioxidant substance may be glutathione peroxidase, superoxide dismutase, catalase, co-enzyme Q10 or honey.

The prebiotic may contain fructose, galactose, mannose, soy or inulin.

The probiotic bacteria may be lactobacilli or bifidobacteria, lactococcus, streptococcus, leuconostoccus, pediococcus or enterococcus.

When the chewing gum-containing tablet contains an active ingredient, it may impart to the consumer benefits such as oral care, breath freshness, pharmaceutical or nutritive advantages.

The present invention also provides a process for the preparation of a chewing gum-containing tablet according to the invention which comprises mixing a particulated gum base with a particulated tablet base material and compressing the mixture in a tablet press to enable it to bind together and form a firm compact product.

The tablet press comprises a die and a punch and the basic principle of compression applies wherein the die is filled with powder and compressed by the punch being lowered under pressure and maintained on the powder for a period of time known as the dwell time to form the tablet after which the tablet is ejected. Many shapes and sizes of tablet may be made by varying the shape of the die and punch, e.g. circular, briquette, pillow, etc.

Upon initial mastication, the tablet is broken into smaller particles and presents a crumbly texture in the mouth. Continued mastication converts the crumbly texture to a coalesced wad of chewing gum to be enjoyed in the same manner as conventional chewing gum. In the mouth, the tablet initially has a crumbly texture which lasts for a certain period of time before it becomes a normal cohesive chewing gum. The period of crumbliness varies according to rate of chew and the ratio between the gum and tablet material. For a slow chew according to the recipe this period may vary from 0.5 seconds to 1 minute.

### EXAMPLES

The following Examples further describe the invention by way of illustration only. The gum base used in all the Examples is ARTICA-T made by Cafosa Gum S/A of Barcelona, Spain.

### Example 1

The following formulation is used to make a large circular chewing gum with a hole in the middle. The gum base and the sorbitol are used in powder form having an average particle size of 40 microns. The flavor is a combination of powder and liquid.

| | |
|---|---|
| Gum Base | 21.3% |
| Sorbitol | 72.1% |
| CGMP | 5% |
| Magnesium stearate | 0.5% |
| Flavor (powder + liquid) | 1.1% |

The above ingredients are filled into the die of a tablet press comprising a suitably shaped die and punch and compressed by the punch being lowered under pressure which is maintained on the powder for a period of time known as the dwell time to bond the particles together and compact them to form the tablet after which the tablet is ejected.

In the mouth, the tablet initially has a crumbly texture which lasts for a certain period of time and then becomes a normal cohesive chewing gum.

### Example 2

245.95 parts of a Cafosa Gum/Sorbitol premix containing the ingredients in the same proportion as in Example 1 having an average particle size of 40 microns are mixed with the following ingredients

| | |
|---|---|
| Magnesium stearate (lubricant) | 1.25 parts |
| Mint Oil | 1.30 parts |
| Mint powder | 1.00 parts |
| Menthol Trusil | 0.5 parts |

The above mixture was compressed as in Example 1 to give a mint-flavored chewing gum tablet.

In the mouth, the tablet initially has a crumbly texture which lasts for a certain period of time and then becomes a normal cohesive chewing gum.

### Example 3

240 parts of a Cafosa Gum/Sorbitol premix containing the ingredients in the same proportion as in Example 1 having an average particle size of 40 microns are mixed with the following ingredients

| | |
|---|---|
| Magnesium stearate (lubricant) | 1.25 parts |
| Peach flavor | 5.00 parts |
| Malic acid | 3.50 parts |
| Aspartame | 0.25 parts |

The above mixture was compressed as in Example 1 to give a fruit-flavored chewing gum tablet.

In the mouth, the tablet initially has a crumbly texture which lasts for a certain period of time and then becomes a normal cohesive chewing gum.

### Example 4

The following mixture was compressed as in Example 1 to give a flavored chewing gum tablet.

| | |
|---|---|
| Gum base | 26% |
| Xylitol | 28% |
| Isomalt PF | 39.9% |
| Lycasin | 0.6% |
| Liquid flavor (mint) | 0.1% |

The above composition of the tablet material gives a crumbliness which lasts for only about 0.5 seconds and then becomes a normal cohesive chewing gum.

### Example 5

The following mixture was compressed as in Example 1 to give a flavored chewing gum tablet.

| | |
|---|---|
| Gum base | 26% |
| Sugar | 74% |
| Glucose syrup 42 DE | 5.3% |
| Liquid Flavor (mint) | 0.1% |

The above composition of the tablet material gives a crumbliness which lasts for only about 0.5 seconds and then becomes a normal cohesive chewing gum.

1. A chewing gum-containing tablet comprising a compressed mixture of gum base and a tablet base, such that, when masticated, the tablet initially exhibits a first crumbly stage in which the tablet breaks into particles, followed by a second chewing gum stage in which the particles form a wad of chewing gum.

2. The chewing gum-containing tablet of claim 1 prepared from a gum base and a tablet base material in particulate form.

3. The chewing gum-containing tablet of claim 1 prepared by compressing a mixture of a gum base and a tablet base material in powder form.

4. The chewing gum-containing tablet of claim 2 wherein the gum base is a plasticized rubber or polymer which optionally includes texturizers, anti-tacking agents or antioxidants.

5. The chewing gum-containing tablet of claim 2 wherein the tablet base material is a sugar or a polyol.

6. The chewing gum-containing tablet of claim 2 wherein the tablet base material is sucrose, fructose, lactose, dextrose, sorbitol, mannitol, maltitol, xylitol, isomalt, glucose syrup, maltitol syrup or erithrithol.

7. The chewing gum-containing tablet of claim 1 which further comprises one or more of a binder, a lubricant, a flavor or a color.

8. A chewing gum-containing tablet of claim 1 which further comprises a pharmaceutical, medicated, nutritive or functional ingredient, a dental vehicle or a breath freshener.

9. A process for the preparation of a chewing gum-containing which comprises mixing a particulated gum base with a particulated tablet base material and compressing the mixture in a tablet press to enable it to bind together and form a firm compact tablet such that, when masticated, the tablet initially exhibits a first crumbly stage in which the tablet breaks into particles, followed by a second chewing gum stage in which the particles form a wad of chewing gum.

10. The process of claim 9 wherein the gum base is a plasticized rubber or polymer which optionally includes texturizers, anti-tacking agents or antioxidants.

11. The process of claim 9 wherein the tablet base material is a sugar or a polyol.

12. The process of claim 9 wherein the tablet base material is sucrose, fructose, lactose, dextrose, sorbitol, mannitol, maltitol, xylitol, isomalt, glucose syrup, maltitol syrup or erithrithol.

13. The process of claim 9 which further comprises adding one or more of a binder, a lubricant, a flavor or a color to the mixture prior to compressing.

14. The process of claim 9 which further comprises adding one or more of a pharmaceutical, medicated, nutritive or functional ingredient, a dental vehicle or a breath freshener to the mixture prior to compressing.
